(19) United States
(12) Patent Application Publication
(10) Pub. No.: US 2026/0320642 A1
(43) Pub. Date: Oct. 15, 2026

(54) SYSTEM AND METHOD FOR ADMINISTERING DISCOUNTS IN A SUPPLY CHAIN

(71) Applicant: CENCORA, INC., CONSHOHOCKEN, PA (US)

(72) Inventors: Tyler Novotny, Lafayette Hill, PA (US); Caleb Debenham, Philadelphia, PA (US); Tim Weber, Chapel Hill, NC (US); Elizabeth B. Gibson, Hamburg, NY (US); David Senior, Newtown Square, PA (US)

(21) Appl. No.: 19/647,466

(22) Filed: Apr. 14, 2026

Related U.S. Application Data
(60) Provisional application No. 63/788,295, filed on Apr. 14, 2025.

(51) Int. Cl. G06Q 30/0207

(52) U.S. Cl. CPC G06Q 30/0225; G06Q 30/0215

(57) ABSTRACT

A method of administering discounts for pharmaceuticals and like products is provided. Claims data from a pharmacy for transactions eligible for discount are obtained and aggregated with claims data for transactions eligible for discount obtained from a manufacturer. The claims data from the pharmacy are matched with claims data from the manufacturer to ensure that only one discount is applied per eligible transaction. Graphical user interfaces are generated and provided to the dispensing entity and manufacturer that provide transparency with respect to applied and unapplied discounts. The claims data may include maximum fair price (MFP) data claims required by the Inflation Reduction Act of 2022 and 340B claims data required by the 340B Drug Pricing Program of 1992.

### CROSS REFERENCE TO RELATED APPLICATIONS

This application claims the benefit under 35 USC § 119(e) of U.S. Provisional Patent Application No. 63/788,295 filed Apr. 14, 2025.

### BACKGROUND

The present disclosure relates to a system and method for administering pricing, rebates, discounts, and the like in a supply chain.

The supply chain in various industries requires the administration of product pricing and the use of rebates, discounts, and the like through a supply chain for the product. Administrating such activities can be difficult for some industries, particularly with respect to issues concerning transaction transparency, request for and providing proper discounts, rebates, or the like, compliance with laws and regulations, and eliminating possible excess payment of rebates for any given transaction. By way of example, administering pricing, discounts, rebates, and the like in a supply chain, such as a pharmacy supply chain, in a transparent and competent manner is desired by all stakeholder in such a supply chain.

For instance, the 340B Drug Pricing Program is a US federal government program that was created in 1992 and that requires drug manufacturers to provide outpatient drugs to eligible health care organizations and covered entities at significantly reduced prices. More specifically, Section 340B of the Public Health Service Act requires pharmaceutical manufacturers participating in Medicaid to sell outpatient drugs at discounted prices to health care organizations that care for many uninsured and low-income patients.

In addition, as recently as Aug. 16, 2022, Congress passed, and President Biden signed into law H.R.5376—Inflation Reduction Act of 2022; this act includes several provisions to lower prescription drug costs for people with Medicare and reduce drug spending by the federal government. On Mar. 15, 2023, the Department of Health and Human Services (HHS) provided a memorandum with initial guidance regarding the implementation of sections 11001 and 11002 of the Inflation Reduction Act (IRA) (PL 117169), which established the Medicare Drug Price Negotiation Program to negotiate Maximum Fair Prices (MFPs) for certain high expenditure, single-source drugs, and biological products. The requirements for this program are described in sections 1191 through 1198 of the Social Security Act as added by sections 11001 and 11002 of the IRA. Sections 11001(c) and 11002(c) of the IRA direct the Secretary to implement the Negotiation Program for years 2026, 2027, and 2028 by program instruction or other forms of program guidance.

As a result, it may be desired by pharmaceutical manufacturers to use a so-called prospective option to make available to patients or eligible entities the lower of Maximum Fair Price (MFP) or 340B ceiling price for selected products, so that the federal requirements of law H.R. 5376—Inflation Reduction Act of 2022 are met.

This new legislative ability for Medicare to negotiate prices creates a new reference price of Maximum Fair Price (MFP) which is somewhat similar in nature to 340B ceiling prices discussed above and only applicable to select products billed to Medicare Part D (in 2026 and 2027) and Medicare Parts B and D (after 2027). Manufacturers have been granted the ability to select how MFP pricing is applied, which will require a new way for manufacturers to ensure an MFP priced product is used only for Medicare patients under the law.

Since IRA passage in 2022, no solution is believed available in the marketplace to administer MFP pricing accurately and without delay or duplication from current practices, while maintaining transparency to all stakeholders in the supply chain.

### SUMMARY

According to an embodiment, a method of administering discounts, rebates, or the like for pharmaceuticals is provided. Claims data from Part B and D dispensing entities for Maximum Fair Prices (MFP) eligible transactions are obtained and aggregated with claims data for MFP eligible transactions obtained from a manufacturer. The claims data from the Part B and D dispensing entities are matched with claims data from the manufacturer to ensure that only one discount is applied or paid per eligible transaction. Graphical user interfaces are generated and provided to the Part B and D dispensing entity and manufacturer that provide transparency with respect to applied and unapplied discount and/or rebate payments. The claims data may include maximum fair price (MFP) data claims required by the Inflation Reduction Act of 2022 and 340B claims data required by the 340B Drug Pricing Program of 1992 for selected MFP drugs.

### BRIEF DESCRIPTION OF THE DRAWINGS

The foregoing and other objects, features and advantages of the embodiments disclosed herein should become apparent from the following description when taken in conjunction with the accompanying drawings.

FIG. 1 is a diagram of a conventional pharmacy supply chain structure.

FIG. 2 is a diagram of a pharmacy supply chain structure using MFP reconciliations according to an embodiment.

FIG. 3 is a diagram of an MFP claim ledger according to an embodiment.

FIGS. 4-6 are screen prints of a graphical user interface of a manufacturer's dashboard of a system according to an embodiment.

FIGS. 7-9 are screen prints of a graphical user interface of a pharmacy's dashboard of a system according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known devices, apparatus, methods and structures have not been described in detail so as not to unnecessarily obscure the embodiments.

According to some embodiments disclosed herein, a system and/or service is provided that permits drug and/or durable medical equipment manufacturers and the like to work in a process that streamlines data and reduces potential disputes with Part B and D (prescription drug) dispensing entities, such as pharmacies and the like, in a supply chain. These embodiments should help manufacturers meet their legal obligations as discussed with the IRA, for instance, as well as to ensure Part B and D dispensing entities are paid in a timely manner, provide a prospective approach that allows manufacturers to simplify data requirements (Data: data supporting Payment Elements list and Method for determining MFP discount/Refund amount), mitigate adjustments, refunds or disputes with Part D dispensing entities, and limit potential time needed to solve duplicate discount risk. This service can also connect with 340B third-party administrators (TPAs) for obtaining 340B data so that a manufacturer should be able to identify and prevent improper stacking of discounts/rebates between MFP products and 340B products.

Accordingly, a potential user/customer for this solution would include, for example, pharmaceutical manufacturers that are required by law to make available MFP pricing on eligible Medicare claims, need a solution that ensures MFP price is only applied to eligible claims and reduces duplicate discounts being provided on products, require data to validate MFP eligible claims, and need to find a way to administer MFP pricing either internally or externally or both.

Potential users/customers for this solution may also include The Centers for Medicare & Medicaid Services (CMS), a federal agency within the United States Department of Health and Human Services (HHS) that administers the Medicare program and works in partnership with state governments to administer Medicaid, the Children's Health Insurance Program (CHIP), and health insurance portability standards. The CMS is required by law to administer the IRA's MFP requirement, will need transparency to the model to effectively regulate and monitor, will need data to appropriately report MFP impact, and will likely require manufacturers to fund any infrastructure required to administer MFP pricing to providers.

Another potential user for this solution will include all purchasers of pharmaceuticals and the like that are billed for reimbursement under Medicare Part D or B (i.e., retail pharmacies, LTC pharmacies, hospitals, etc.). These users/entities will need a provider-friendly model to ease process of obtaining MFP pricing for eligible products, will need transparency to understand MFP priced product availability, and will have internal costs to collate, submit, and reconcile data as well as monitor MFP pricing and product availability.

The proposed solution leverages a trusted intermediary which maintains positive relationships with all stakeholders and provides transparency needed for such a model to be successful.

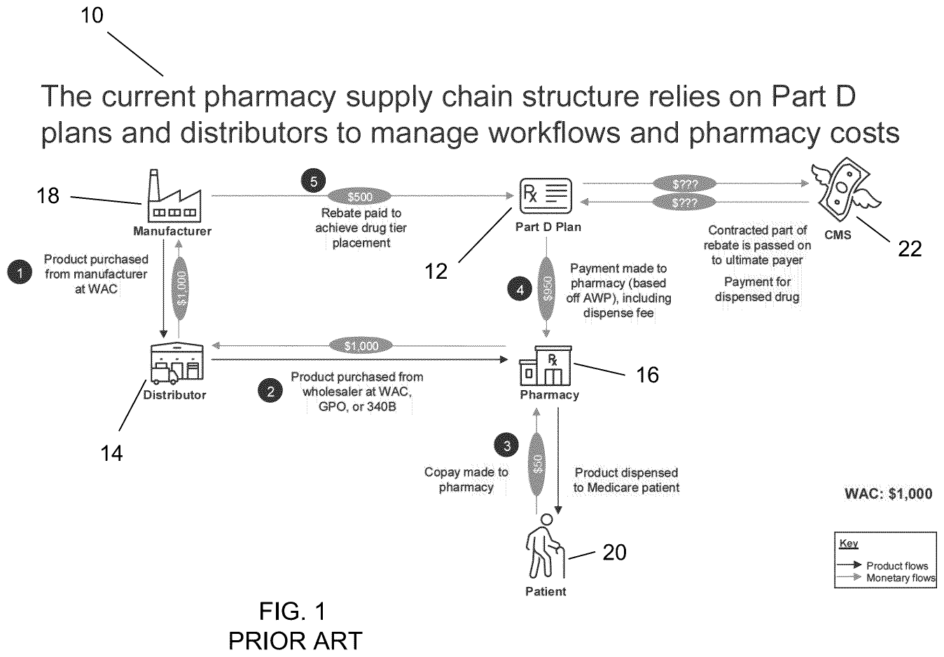

Before turning to the present invention, a conventional pharmacy supply chain structure, as an example, is discussed with respect to FIG. 1. In the system 10 shown in FIG. 1, workflows and pharmacy costs are managed primarily by pharmacy benefit managers (PBMs) 12 and distributors/wholesalers 14.

The PBM 12 is a third-party administrator of prescription drug programs for commercial health plans, self-insured employer plans, Medicare Part D plans, Medicare Part B plans, the Federal Employees Health Benefits Program, manufacturer direct-to-consumer programs, prescription drug discount programs, managed Medicaid programs, and state government employee plans. PBMs 12 operate inside of integrated healthcare systems as part of retail pharmacies and as part of insurance companies. The role of pharmacy benefit managers 12 includes managing formularies, maintaining a pharmacy network, setting up rebate payments to pharmacies, processing prescription drug claims, providing mail order services, and managing drug use. PBMs 12 play a role as the middlemen between pharmacies 16, drug manufacturers 18, wholesalers/distributors 14, and health insurance plan companies and the like.

In the United States, health insurance plans often hire an outside company to handle price negotiations, insurance claims, and distribution of prescription drugs. Health plans which use such pharmacy benefit managers 12 include commercial health plans, self-insured employer plans, Medicare Part D plans, Medicare Part B plans, the Federal Employees Health Benefits Program, and state government employee plans. PBMs 12 are designed to aggregate the collective buying power of enrollees through their client health plans, enabling plan sponsors and individuals to obtain rebate value for their prescription drugs and the like. PBMs 12 negotiate price reimbursement with providers, rebates from pharmaceutical manufacturers, and operate mail-service pharmacies.

In the example shown in FIG. 1, a drug manufacturer 18 sells a product to a distributor 14 at a Wholesale Acquisition Cost (WAC), which is the manufacturer's list price of the drug when sold to the wholesaler/distributor 14. WAC is an estimate of the manufacturer's list price for a drug to wholesalers or direct purchasers, but does not include discounts or rebates. WAC is the most common benchmark used today by pharmacies to buy drugs from wholesalers. Publicly disclosed or listed WAC amounts often do not reflect all available discounts or rebates.

In the example shown in FIG. 1, the manufacture 18 sells a particular product to the distributor 14 at WAC for $1000. The pharmacy 16 purchases the product from the distributor 14 either at the WAC, i.e., $1000, group purchasing organization (GPO) price, or at a 340B set price (as referenced above). The product is dispensed to a Medicare patient 20 by the pharmacy 16 (i.e., Part D dispensing entity), with perhaps a copay amount being paid by the Medicare patient 20 to the pharmacy 16. In the example, the copay is $50 paid to the pharmacy 16.

The PBM 12 reimburses the pharmacy 16 the remainder of the price of the product, such as based on an average wholesale price (AWP), including dispense fee. In the example, shown in FIG. 1, the amount paid to the pharmacy 16 for the Part D drug dispensed is $950 (WAC less the copay already received). The PBM 12 is responsible for obtaining any type of rebate or reduced cost from the manufacturer 18 and passes on a contracted part of the rebate to the ultimate health plan 22 (i.e., the insurance company, the government, etc.). The PBM 12 also receives a payment for the dispensed drug from the health plan 22. (The values for the contracted part of the rebate and payment for the dispensed drug between the PBM 12 and health plan 22 are shown as “???” in FIG. 1 as information not verifiable by the public.)

The arrangement shown in FIG. 1 is relatively complicated and it is difficult to ensure that proper rebates and discounts are accurately requested and received. In some cases, the rebate or discount is not accurately administered or may be unknowingly administered multiple times resulting in excess payments of rebates and/or discounts.

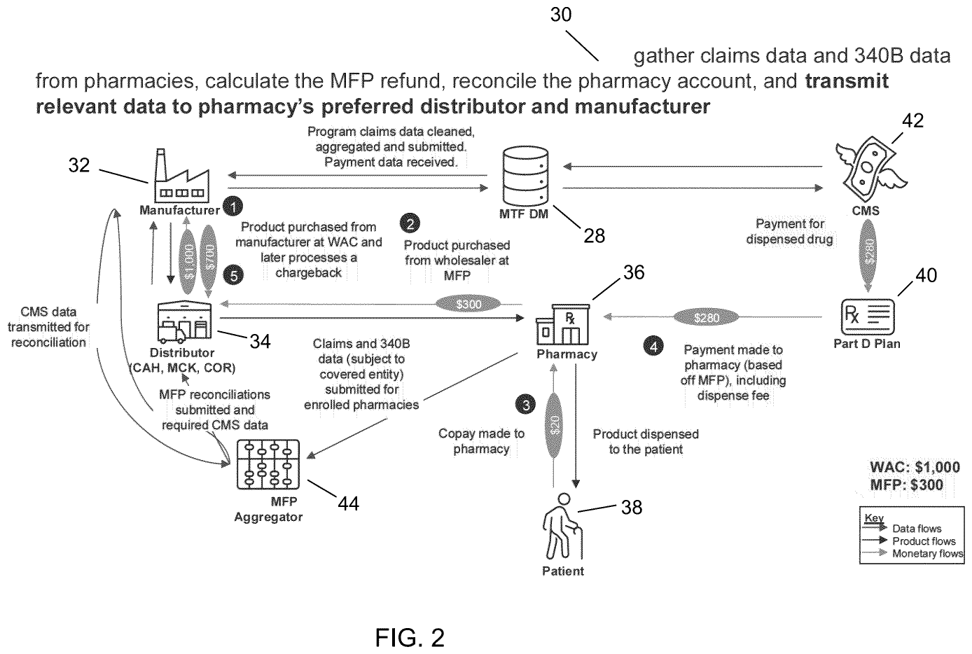

The system/solution according to the present invention is shown in FIG. 2 and is a process/service 30 for gathering claim data and 340B data from Part D dispensing entities or the like, calculating a discount based on Maximum Fair Price (MFP) as required by law for an eligible transaction, reconciling the dispensing entity's account, and transmitting relevant data to the distributor and manufacturer.

In the example provided by FIG. 2, a manufacturer 32 sells a product at WAC ($1000 in the example) to a distributor 34. The manufacturer 32 later processes a chargeback to an account of the distributor 34 or otherwise sends a payment as is discussed below. In the example, the chargeback is $700 since the MFP for the drug is $300 (i.e., the drug is discounted by $700 if eligible for MFP pricing).

A pharmacy 36 (i.e., Part D dispensing entity) purchases the eligible product for a Medicare patient 38 from the distributor 34 at the MFP ($300 in the example), not WAC. The pharmacy 36 dispenses the product to the Medicare patient 38 and may receive a copay from the patient 38 (i.e., $20 in this example). The pharmacy 36 is then reimbursed by the PBM 40 such that the reimbursement is based on the remaining cost of the product based on MFP plus any dispense fee. In the example, $280 is provided to the pharmacy 36 from the PBM 40. The PBM 40 is reimbursed ($280 in the example) by the health plan 42.

The above solution shown in FIG. 2 is much more accurate and straight forward as compared to the arrangement shown in FIG. 1 and reduces errors and speeds the process.

For purposes of achieving the solution shown in FIG. 2, an MFP aggregator service 44 is utilized. The MFP aggregator service 44 gathers claims data and 340B data directly from the pharmacy 36 concerning transactions (provided the pharmacy is enrolled for the MFP aggregator service). Based on the information provided to the CMS 42 by the PBM 40, the CMS 42 prepares program claims data that is cleaned, aggregated, and then submitted to the manufacturer 32. This data may be made available to the manufacturer 32 via a Medicare Transaction Facilitator Data Module (MTF DM) 28. The manufacturer 32 provides this data to the MFP aggregator service 44, which then provides MFP reconciliations to the distributor 34 and to the manufacturer 32. This data may also be provided to the MTF DM 28, for instance, by the manufacturer 32. This data ensures the chargeback paid to the distributor 34 from the manufacturer 32 is accurate and timely.

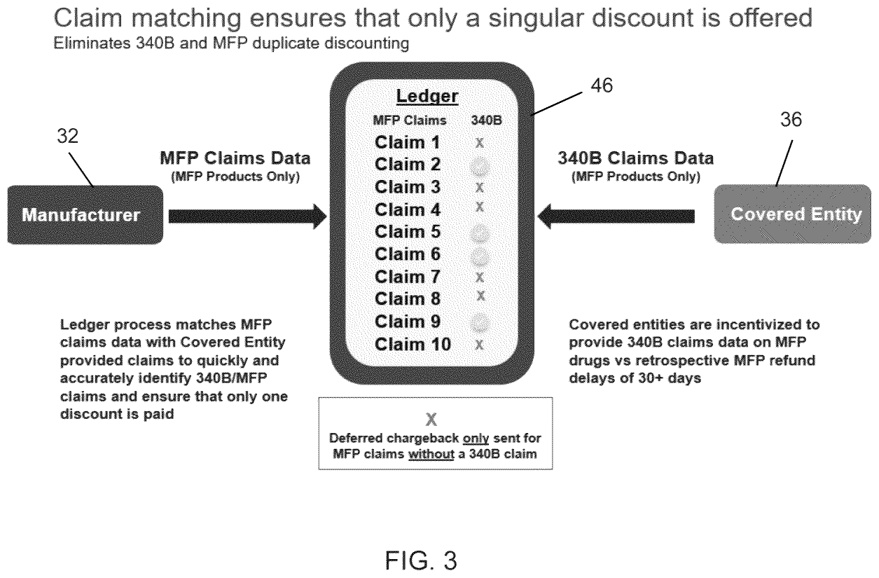

By way of example, FIG. 3 shows a ledger 46 generated and utilized by the MFP aggregator service 44. The ledger 46 matches claim data and applies logic compliant with IRA that ensures that only a single discount, rebate, or chargeback is offered/made per transaction. The claims data provided by the manufacturer 32 is compared against the claims data provided by a covered dispensing entity, such as a pharmacy. In the ledger 46, the MFP claims data is matched with claims data provided by covered dispensing entities to identify 340B/MFP claims and ensure that only one discount and/or rebate is provided by the manufacturer 32 to the distributor 34. In addition, covered dispensing entities, such as pharmacy 36, are incentivized by the disclosed solution to provide 340B claims data on MFP drugs due to risk of delayed retroactive rebate payments. As shown in FIG. 3, the chargeback provided to the distributor 34 from the manufacturer 32 is not deferred for claims that include a 340B claim (i.e., for claims 2, 5, 6, and 9 in the example shown in FIG. 3). On the contrary, for claims not including a 340B claim, the chargeback is deferred (i.e., in the example, for claims 1, 3, 4, 7, 8, and 10 which are each marked with an “X” in FIG. 3).

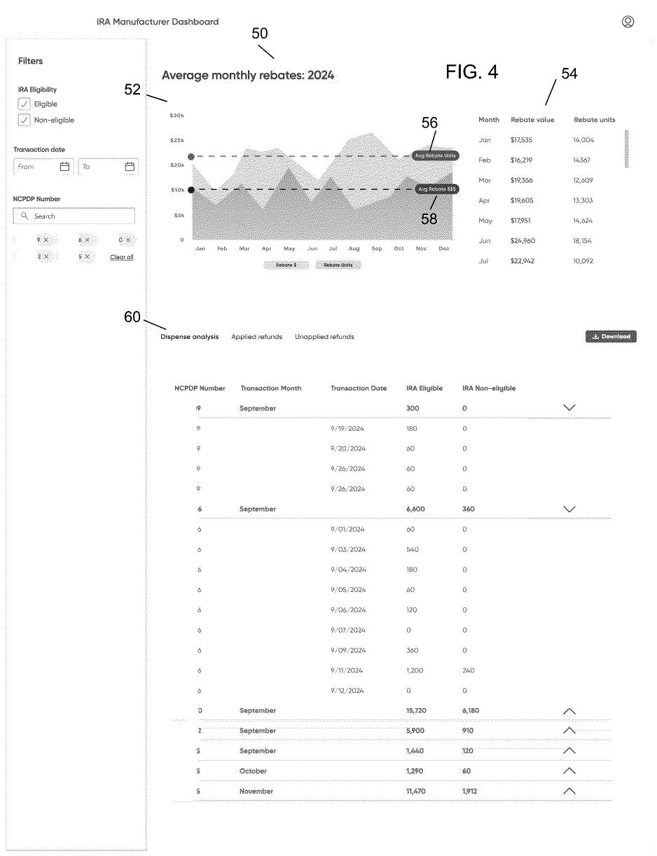

According to an embodiment, the MFP aggregator service 44 provides dashboards or graphic user interfaces to subscribers of the service as shown, for instance, in FIGS. 4-9.

A dashboard 50 for a manufacturer is shown in FIG. 4. The dashboard 50 includes a chart 52 and table 54 showing dollar value of rebates and number of rebate units per month or other time period. The chart 52 may include a showing of the average rebate units 56 and average rebate dollars 58 for any time period, such as a monthly average. The dashboard 50 shown in FIG. 4 also includes a listing of dispense analysis 60 for each pharmacy NCPDP number. The data provides transaction dates for each transaction with a pharmacy and whether the transaction was an IRA eligible transaction or an IRA non-eligible transaction.

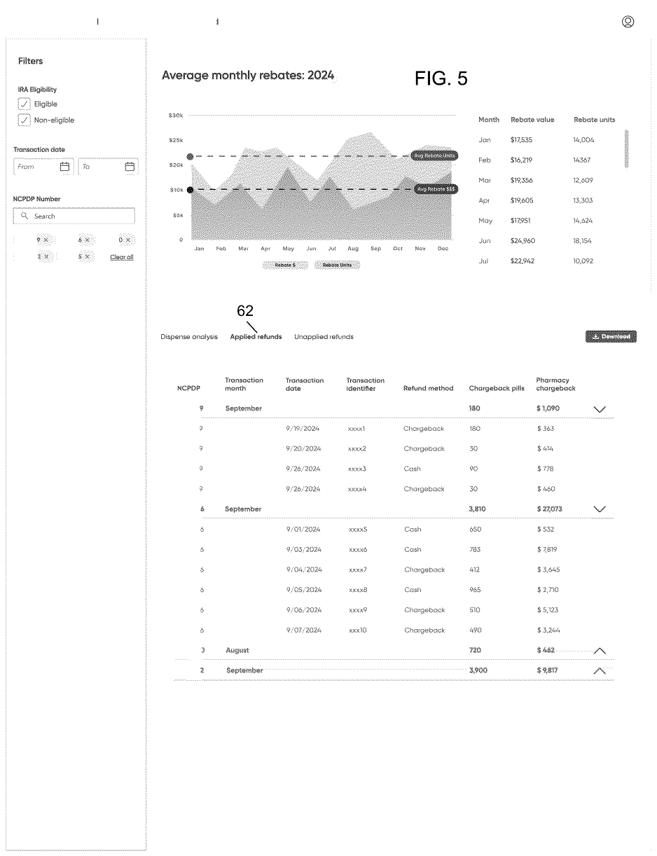

As shown in FIG. 5, data concerning applied refunds 62 is provided for each pharmacy by month in the manufacturer dashboard 50. The data may include transaction date, transaction identifier, refund method (chargeback or cash), the number of pills, and the chargeback dollar amount.

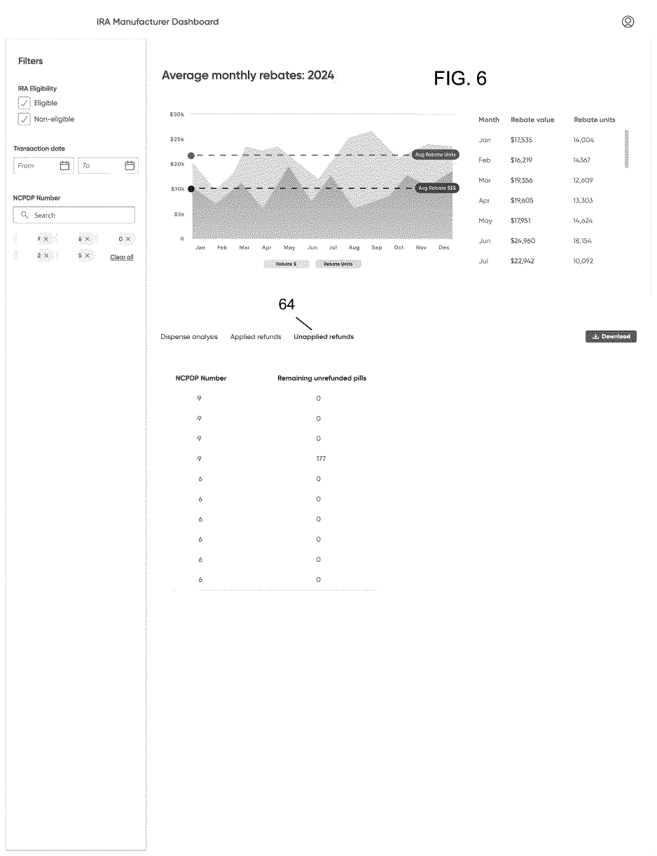

As shown in FIG. 6, data concerning unapplied refunds 64 is provided in the manufacturer dashboard 50 for each pharmacy. Thus, for instance, the data may include the remaining amount of unrefunded pills for each pharmacy.

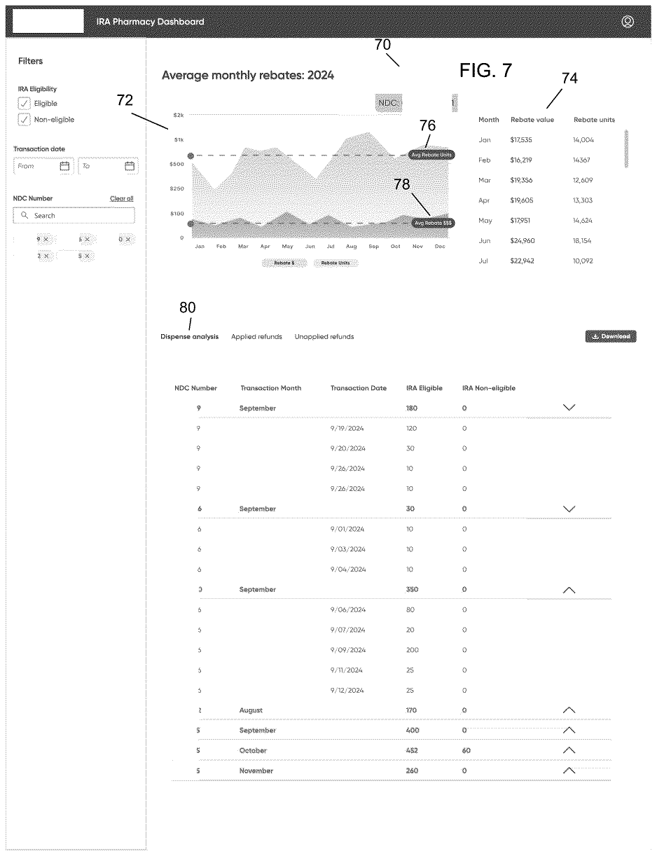

A dashboard 70 for a pharmacy subscriber is shown in FIG. 7. The dashboard 70 includes a chart 72 and table 74 showing dollar value of rebates and number of rebate units per month or other time period. The chart 72 may include a showing of the average rebate units 76 and average rebate dollars 78 for any time period, such as a monthly average. The dashboard 70 shown in FIG. 7 also includes a listing of dispense analysis 80 for each drug NDC number. The data provides transaction dates for each transaction and whether the transaction was an IRA eligible transaction or an IRA non-eligible transaction.

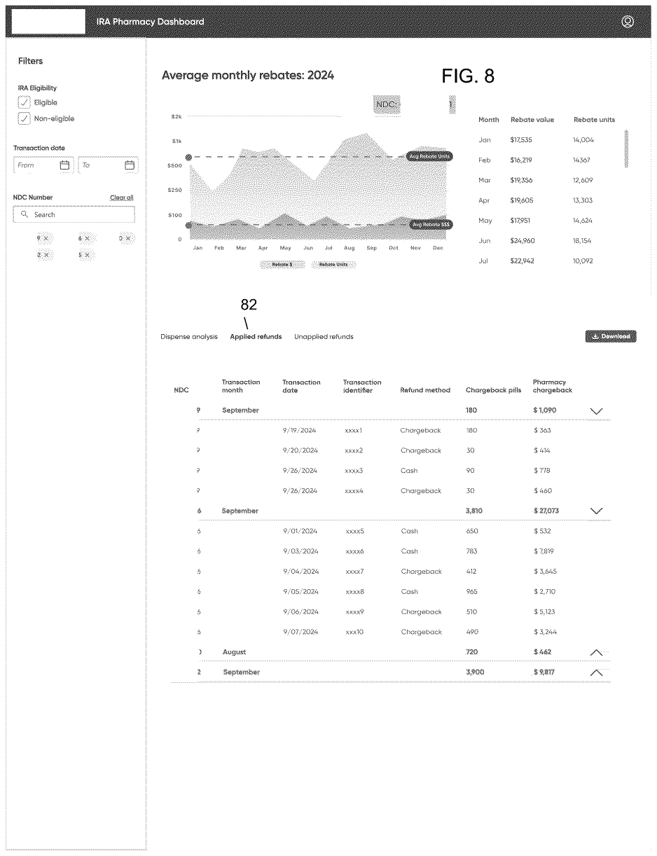

As shown in FIG. 8, data concerning applied refunds 82 for each drug by month is provided in the pharmacy rebate dashboard 70. The data may include transaction date, transaction identifier, refund method (chargeback or cash), the number of pills, and the chargeback dollar amount.

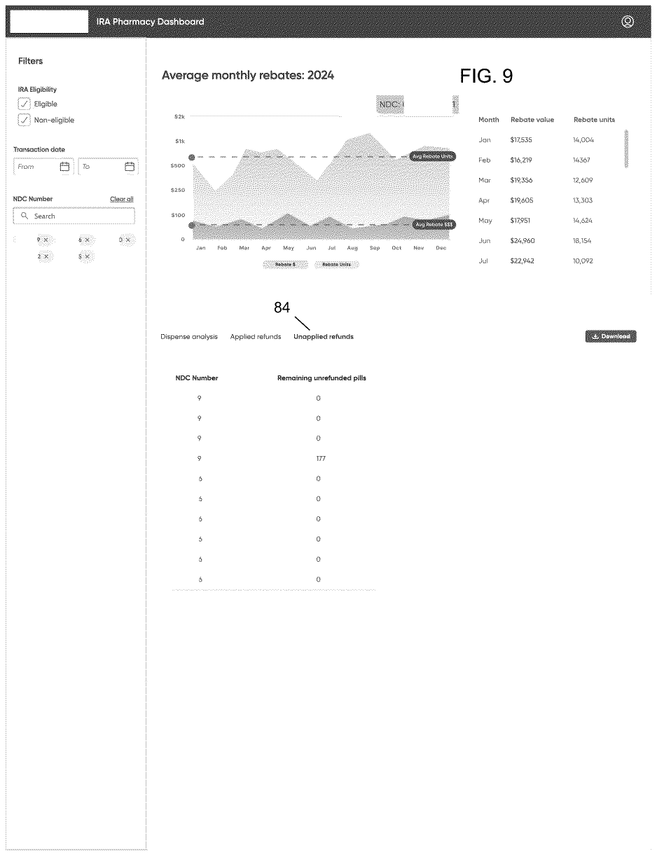

As shown in FIG. 9, data concerning unapplied refunds 84 is provided in the pharmacy rebate dashboard 70 for each drug. Thus, for instance, the data may include the remaining amount of unrefunded pills for each drug.

For each of the dashboards, 50 and 70, discussed above, the user may filter the results by IRA eligibility or non-eligibility, by transaction date period, and by a particular pharmacy or pharmacies or a particular drug type or types.

Of course, the above information is provided for purposes of example and the dashboards may include further or less information. However, the dashboards provide transparent information concerning all transactions to the manufacturer, pharmacy, distributer, and CMS.

The MFP aggregator service 44 discussed above may be implemented in hardware or software, and may be implemented in a wide variety of configurations, platforms, and architectures. Therefore, some or all of the operations in the embodiments discussed above may be performed in hardware, in software, or both. For example, at least some of the operations may be implemented using program instructions, operating system, or in firmware.

The foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure.

We claim:

1. A method of administering discounts for pharmaceuticals, comprising the steps of:
obtaining and aggregating claims data from a dispensing entity for transactions eligible for discount and claims data from a manufacturer for transactions eligible for discount;
matching the claims data from the dispensing entity with claims data from the manufacturer to ensure accuracy of discounts and that only one discount is applied per eligible transaction; and
generating and providing graphical user interfaces to the dispensing entity and manufacturer that provide transparency with respect to applied and unapplied discounts.

2. The method according to claim 1, wherein the claims data include one or more discounts or rebates required by law or a government.

3. The method according to claim 2, wherein the claims data includes maximum fair price (MFP) data claims required by the Inflation Reduction Act of 2022.

4. The method according to claim 2, wherein the claims data includes 340B claims data required by the 340B Drug Pricing Program of 1992.

5. The method according to claim 4, wherein discounts are provided by chargeback for MFP claims with a matching 340B claim.

6. The method according to claim 4, wherein discounts are provided by deferred chargeback for MFP claims without a matching 340B claim.

7. The method according to claim 1, further comprising the step of calculating one or more discounts from the claims data.

8. The method according to claim 7, further comprising the step of reconciling an account of the pharmacy with respect to transactions eligible for discounts.

9. The method according to claim 8, further comprising the step of transmitting reconciliations to the manufacturer or a distributor of the manufacturer.

10. The method according to claim 9, wherein the discount is provided by chargeback from the manufacturer to the distributor and wherein the dispensing entity only submits payment to the distributor in an amount already reduced by the discount.

11. The method according to claim 1, wherein the graphical user interface includes a manufacturer dashboard including at least one of a chart and table indicating at least one of an amount of discounts or rebates or an amount of discount or rebate units during a pre-defined transaction period.

12. The method according to claim 11, wherein the manufacturer dashboard includes an indication of a monthly average amount of discounts or rebates or a monthly average amount of discount or rebate units during the pre-defined transaction period.

13. The method according to claim 11, wherein the manufacturer dashboard includes a listing of transactions by dispensing entity.

14. The method according to claim 11, wherein the manufacturer dashboard includes a listing of discount or refund transactions by dispensing entity.

15. The method according to claim 11, wherein the manufacturer dashboard includes a listing of unapplied discounts or refunds by dispensing entity.

16. The method according to claim 1, wherein the graphical user interface includes a dispensing entity dashboard including at least one of a chart and table indicating at least one of an amount of discounts or rebates or an amount of discount or rebate units during a pre-defined transaction period.

17. The method according to claim 16, wherein the dispensing entity dashboard includes an indication of a monthly average amount of discounts or rebates or a monthly average amount of discount or rebate units during the pre-defined transaction period.

18. The method according to claim 16, wherein the dispensing entity dashboard includes a listing of transactions by drug.

19. The method according to claim 16, wherein the dispensing entity dashboard includes a listing of discount or refund transactions by drug.

20. The method according to claim 16, wherein the dispensing entity dashboard includes a listing of unapplied discounts or refunds by drug.

21. The method according to claim 1, wherein the manufacturer obtains the claims data from a Medicare Transactions Facilitator Data Module or The Centers for Medicare & Medicaid Services (CMS).

22. The method according to claim 1, wherein the dispensing entities are selected from the group consisting of retail pharmacies, long-term care pharmacies, and hospitals.
